(19) United States
(12) Patent Application Publication
(10) Pub. No.: US 2022/0341623 A1
(43) Pub. Date: Oct. 27, 2022

(54) FLOATING-TYPE HUMIDIFIER

(71) Applicant: MIRO Co., Ltd., INCHEON (KR)

(72) Inventors: Dong Jin SEO, Incheon (KR); Yong Ju OH, Incheon (KR); Min Seok KIM, Incheon (KR)

(21) Appl. No.: 17/763,867

(22) PCT Filed: Mar. 5, 2021
(86) PCT No.: PCT/KR2021/002739

§ 371 Date: Mar. 25, 2022

(30) Foreign Application Priority Data
Aug. 25, 2020 (KR) 10-2020-0107140

(51) Int. Cl. F24F 13/20; F24F 6/12

(52) U.S. Cl. CPC F24F 13/20; F24F 6/12; F24F 2006/008

(57) ABSTRACT

According to an exemplary embodiment of the present invention, a floating-type humidifier includes a lower body which has a buoyancy space formed along an inner edge to float in water and has a water inlet formed so that water flows into a lower center; an upper body formed with a hollow tube communicable with the water inlet; and supporter formed in an elastically deformable closed curve, in which the supporter is in contact with an upper end of the lower body and a lower end of the upper body to couple the lower body and the upper body to each other.

### TECHNICAL FIELD

The present invention relates to a floating-type humidifier, and more particularly, to a floating-type humidifier having an elastically deformable ring shape disposed at a coupling portion of an upper body and a lower body of a floating body.

### BACKGROUND ART

In general, a humidifier is a device that artificially maintains a desired humidity in a dry room. In other words, the humidifier is a device that granulates water by electricity or makes the water into steam to blow it into the room.

Depending on a humidification method, the humidifier includes an ultrasonic humidifier using an ultrasonic vibrator, a heating-type humidifier that heats water with a heater or an electrode bar to emit steam, and a composite humidifier that combines the advantages of the two types.

Recently, among the humidifiers, a floating-type humidifier which is easy in management such as cleaning has been frequently used, and the floating-type humidifier is movably installed to float in a water tank containing water.

Such a conventional floating-type humidifier is installed to float in water contained in the water tank, and has a buoyancy space formed therein for generating buoyancy, and such a buoyancy space is shielded from the outside by coupling an upper body and a lower body.

The air contained in the buoyancy space of such a floating-type humidifier may expand by heat when boiled in hot water for cleaning, and there is a problem of opening a gap between the upper body and the lower body by the expansion of the air.

On the other hand, in the prior art related to the floating-type humidifier, there is Korean Patent Publication No. 10-2015-0090842 “floating-type humidifier” (published date: Aug. 6, 2015).

### DISCLOSURE

### Technical Problem

An object of the present invention is to provide a floating-type humidifier capable of maintaining a stable coupling force so as to prevent water from permeating into a buoyancy space by generating a gap so as not to damage an appearance when air contained in the buoyancy space expands even while easily separating an upper body and a lower body from each other for cleaning, in which the upper body and the lower body shield the buoyancy space of the floating-type humidifier from the outside.

### Technical Solution

According to an aspect of the present invention, there is provided a floating-type humidifier including a lower body which has a buoyancy space formed along an inner edge to float in water and has a water inlet formed so that water flows into a lower center; an upper body formed with a hollow tube communicable with the water inlet; and supporter formed in an elastically deformable closed curve, in which the supporter is in contact with an upper end of the lower body and a lower end of the upper body to couple the lower body and the upper body to each other.

The floating-type humidifier may further include a coupler which is detachably coupled to the upper end of the lower body and the lower end of the upper body.

In an exemplary embodiment, the supporter may be coupled to either the upper end of the lower body or the lower end of the upper body.

In an exemplary embodiment, the supporter may be coupled using any one of an adhesive, a fixed pin, a fixed plate, and a coupling unevenness.

In an exemplary embodiment, the supporter may include a body part formed in an elastically deformable ring shape; an upper support part which extends to an upper portion of the body part to be in close contact with a lower outer circumferential surface of the upper body; and a lower support part which extends to a lower portion of the body part to be in close contact with an upper outer circumferential surface of the lower body.

In an exemplary embodiment, at least one of the upper support part and the lower support part may have one or more grooves formed along an outer periphery thereof.

In an exemplary embodiment, the grooves may be formed in any one shape of a triangle, a rectangle, a polygon, a semicircle, and an ellipse.

In an exemplary embodiment, at least one of the upper support part and the lower support part may be formed to be inclined outward from the body part.

In an exemplary embodiment, the supporter may be made of any of silicone, synthetic rubber, natural rubber, and soft synthetic resin.

In an exemplary embodiment, at least one of the upper body and the lower body may have a detachable handle.

In an exemplary embodiment, the floating-type humidifier may further include an auxiliary supporter which is formed in a ring shape and disposed to be in contact with the water inlet of the lower body and a communication part of the hollow tube.

Detailed contents of other exemplary embodiments are included in the detailed description and the accompanying drawings.

### Advantageous Effects

According to the exemplary embodiments of the present invention, an elastically deformable supporter is disposed between an upper body and a lower body which shield a buoyancy space of a floating-type humidifier from the outside, thereby securing elasticity according to a negative pressure generated by the expansion of the air contained in the buoyancy space.

In addition, the supporter may include a groove at one end to discharge some of the negatively-pressured air to the outside, thereby maintaining a stable coupling force.

### DESCRIPTION OF DRAWINGS

FIG. 1 is a perspective view illustrating a used state of a floating-type humidifier according to an exemplary embodiment of the present invention.

FIG. 2 is an exploded perspective view illustrating the floating-type humidifier according to an exemplary embodiment of the present invention.

FIG. 3 is a perspective view illustrating a state of cross-sectionally treating a part of a supporter according to an exemplary embodiment of the present invention.

FIG. 4 is an exploded perspective view illustrating a floating-type humidifier according to another exemplary embodiment of the present invention.

FIG. 5 is a perspective view illustrating a coupler according to another exemplary embodiment of the present invention.

FIG. 6 is a perspective view illustrating a state of cross-sectionally treating a part of a supporter according to another exemplary embodiment of the present invention.

FIG. 7 is an exploded perspective view illustrating a floating-type humidifier according to yet another exemplary embodiment of the present invention.

FIG. 8 is an exploded perspective view illustrating a floating-type humidifier according to yet another exemplary embodiment of the present invention.

FIGS. 9A and 9B illustrate modified embodiments of the supporter according to an exemplary embodiment of the present invention.

FIG. 10 is an exploded perspective view illustrating a floating-type humidifier according to another exemplary embodiment of the present invention.

FIG. 11 is a perspective view illustrating a state of cross-sectionally treating a part of a supporter according to another exemplary embodiment of the present invention.

FIG. 12 is an exploded perspective view illustrating a floating-type humidifier according to another exemplary embodiment of the present invention.

FIG. 13 is a perspective view illustrating a coupler according to an exemplary embodiment of the present invention.

FIG. 14 is a perspective view illustrating a state of cross-sectionally treating a part of a supporter according to another exemplary embodiment of the present invention.

FIGS. 15A and 15B illustrate modified embodiments of the supporter according to an exemplary embodiment of the present invention.

### MODES FOR THE INVENTION

Advantages and/or features of the present invention, and a method for achieving the advantages and/or features will become obvious with reference to exemplary embodiments to be described below in detail together with the accompanying drawings. However, the present invention is not limited to the exemplary embodiments set forth below, and will be embodied in various different forms. The exemplary embodiments are just for rendering the disclosure of the present invention complete and are set forth to provide a complete understanding of the scope of the invention to a person with ordinary skill in the art to which the present invention pertains, and the present invention will only be defined by the scope of the claims. Like reference numerals refer to like elements throughout the specification.

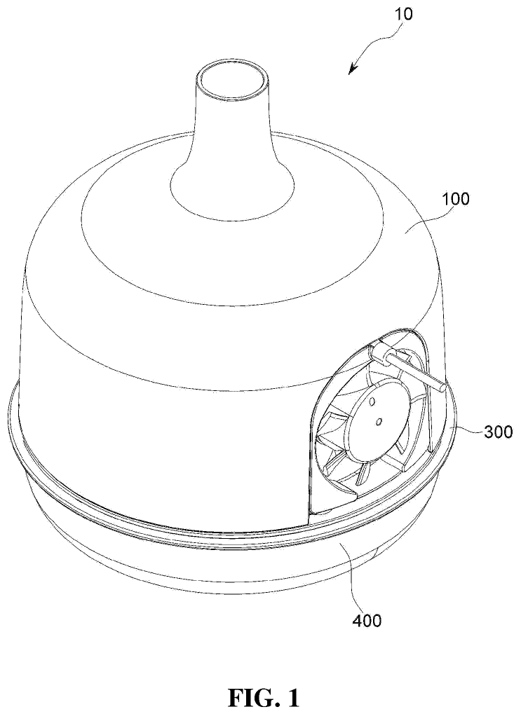

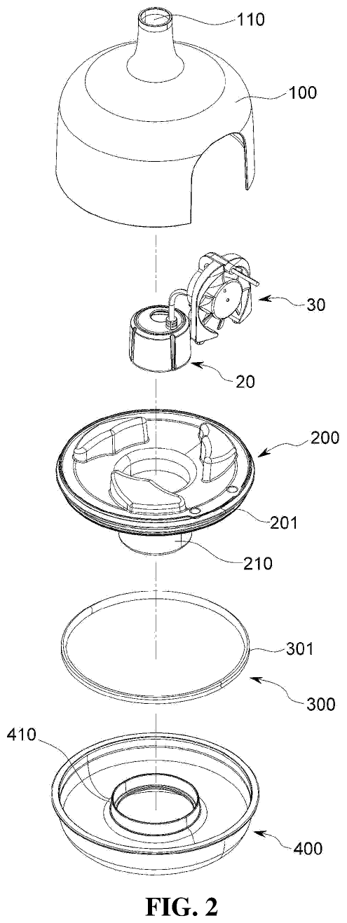

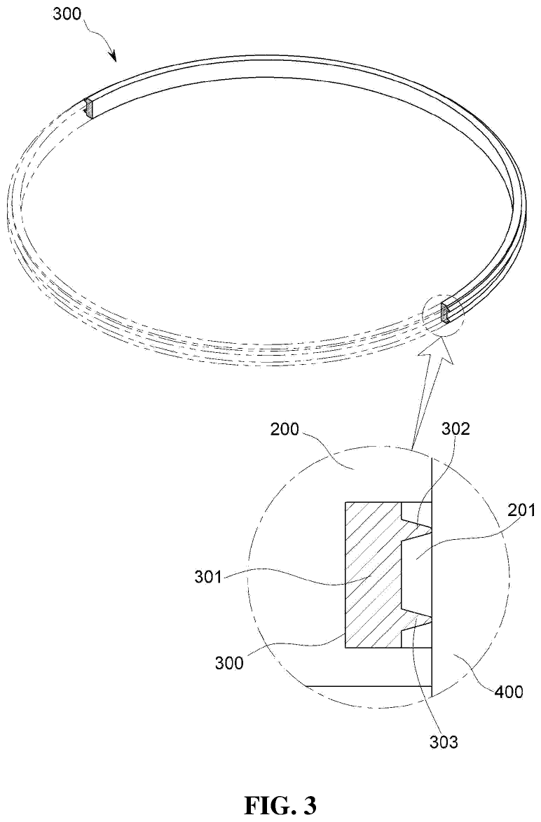

FIG. 1 is a perspective view illustrating a floating-type humidifier according to an exemplary embodiment of the present invention, FIG. 2 is an exploded perspective view illustrating the floating-type humidifier according to an exemplary embodiment of the present invention, and FIG. 3 is a perspective view illustrating a state of cross-sectionally treating a part of a supporter according to an exemplary embodiment of the present invention.

Referring to FIGS. 1 to 3, a floating-type humidifier 10 according to an exemplary embodiment of the present invention includes a cap 100, an upper body 200, a supporter 300, a lower body 400, and the like.

The cap 100 is detachably coupled to an upper end of the upper body 200. More specifically, a lower edge of the cap 100 may be in contact with and coupled to an upper edge of the upper body 200.

The cap 100 may be formed in a pipe shape at a center of the upper end or a gourd bottle shape in which an outer diameter is gradually decreased toward the upper end from the lower end.

The cap 100 is formed with an emission hole 110 through which water particles or steam is discharged on the top surface thereof. Here, the water particles or steam refer to humidified particles, and may be used in the same meaning hereinafter. The emission hole 110 may be implemented in various forms depending on the appearance of the floating-type humidifier 10.

The upper body 200 and the lower body 400 are collectively referred to as a floating body.

The floating body may float in a water tank containing water and may further include an ultrasonic generator 20, a blowing fan 30, and the like therein.

An upper end of the upper body 200 may be coupled to a lower end of the cap 100, and a hollow tube 210 may be formed to vertically penetrate through the center.

The lower body 400 is formed with a buoyancy space along an inner edge to float in water. An inlet 410 is formed below the lower body 400 so that water may flow in, and the inlet 410 communicates with the hollow tube 210 of the upper body 200 along the upper portion.

The ultrasonic generator 20 may be provided in the hollow tube 210 of the upper body 200 to atomize the water flowing into the lower portion into humidified particles by ultrasonic vibration.

Here, a separate power cable (not illustrated) may be connected to the ultrasonic generator 20 or the blowing fan 30 to be described below, and the power cable may extend to the outside through a cable hole (not illustrated). Since the operation of the ultrasonic generator 20 or the blowing fan 30 to be described below is somewhat irrelevant to the main features of the present invention, a detailed description thereof will be omitted for convenience.

The supporter 300 is formed in an elastically deformable closed curve. For example, the supporter 300 may have a ring shape, but is not limited thereto. At least a part of the supporter 300 may be in close contact with an upper end of the lower body 400 and a lower end of the upper body 200. That is, the elastic supporter 300 supports the coupling of the lower body 400 and the upper body 200.

When the supporter 300 is disposed between the upper body 200 and the lower body 400, even if the air provided in the buoyancy space of the lower body 400 expands by heat or the like to increase the internal pressure, the supporter 300 is formed to be elastically deformable, thereby maintaining a stable coupling force.

The supporter 300 may include a body part 301, an upper support part 302, and a lower support part 303.

The supporter 300 may be made of any one of silicone, synthetic rubber, natural rubber, and soft synthetic resin.

The body part 301 is formed in an elastically deformable closed curve. For example, the supporter 300 may have a ring shape, but is not limited thereto.

The upper support part 302 and the lower support part 303 extend outward from the body part 301 to support the coupling of the lower body 400 and the upper body 200. In an exemplary embodiment of the present invention, only two support parts of the upper support part 302 and the lower support part 303 are formed, but it can be modified to form one or several support parts.

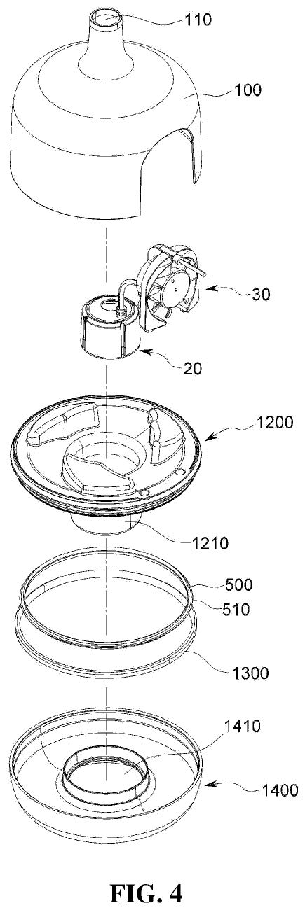

The supporter 300 may be coupled to the upper body 200 or the lower body 400, and may be coupled by a separate coupler, as will be described below with reference to FIG. 4.

The supporter 300 may be coupled to either the upper body 200 or the lower body 400. The supporter 300 may be coupled to either the upper body 200 or the lower body 400 using any one of an adhesive, a fixing pin, a fixing plate, and a coupling unevenness.

For example, in an exemplary embodiment, as illustrated in FIG. 3, if the supporter 300 is coupled to the upper body 200 and the upper body 200 is fitted into the lower body 400, the upper body 200 is inserted into the lower body 400, so that the supporter 300 is disposed between the overlapping surfaces. The body part 301 of the supporter 300 is bonded or force-fitted to a fitting groove 201 of the upper body 200, and the upper support part 302 and the lower support part 303 of the supporter 300 are in contact with the inside of the lower body 400.

In another exemplary embodiment, if the supporter 300 is coupled to the lower body 400 and the upper body 200 is fitted into the lower body 400, the upper body 200 is inserted into the lower body 400 so that the supporter 300 is disposed between the overlapping surfaces. The body part 301 of the supporter 300 is bonded or force-fitted to the lower body 400, and the upper support part 302 and the lower support part 303 of the supporter 300 are in contact with the inside of the upper body 200.

At least one of the upper support part 302 and the lower support part 303 may be formed to be inclined outward from the body part 301.

Accordingly, even when the air provided in the buoyancy space of the lower body 400 expands by heat or the like to increase the internal pressure, the internal air may be easily discharged to the outside.

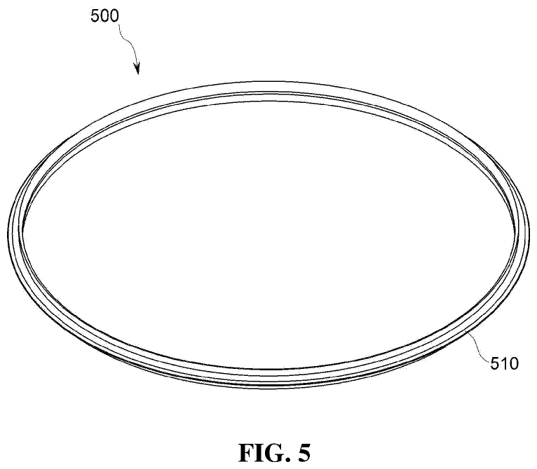

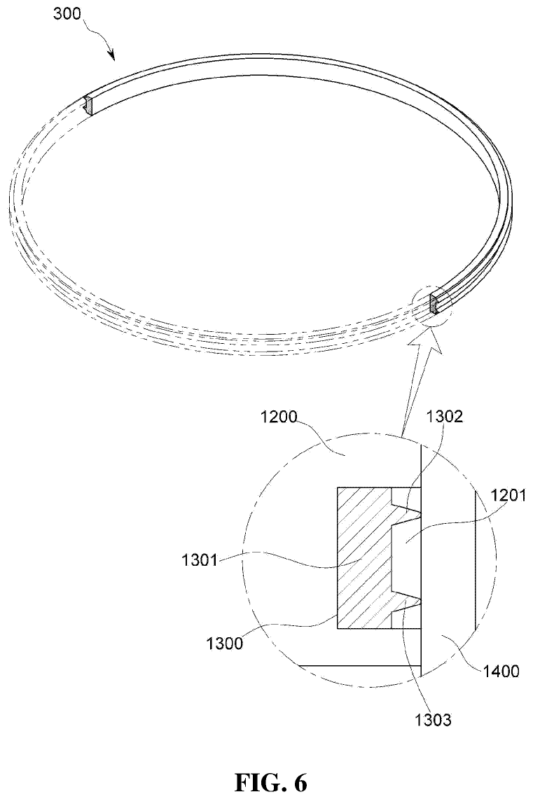

FIG. 4 is an exploded perspective view illustrating a floating-type humidifier according to another exemplary embodiment of the present invention, FIG. 5 is a perspective view illustrating a coupler according to another exemplary embodiment of the present invention, and FIG. 6 is a perspective view illustrating a state of cross-sectionally treating a part of a supporter according to another exemplary embodiment of the present invention.

Referring to FIGS. 4 to 6, a floating-type humidifier 10 according to an exemplary embodiment of the present invention includes a cap 100, an upper body 1200, a coupler 500, a supporter 1300, a lower body 1400, and the like. In the specification of the present invention, since like reference numerals refer to like components, the detailed description of the components described in the previous exemplary embodiment will be omitted.

An upper end of the upper body 1200 may be coupled to a lower end of the cap 100, and a hollow tube 1210 may be formed to vertically penetrate through the center.

The lower body 1400 is formed with a buoyancy space along an inner edge to float in water. An inlet 1410 is formed below the lower body 1400 so that water may flow in, and the inlet 1410 communicates with the hollow tube 1210 of the upper body 1200 along the upper portion.

The ultrasonic generator 20 may be provided in the hollow tube 1210 of the upper body 1200 to atomize the water flowing into the lower portion into humidified particles by ultrasonic vibration.

The coupler 500 may be formed to have a predetermined height along the circumference of the lower end of the upper body 200.

The coupler 500 may further include a supporter coupling groove 510 fitted with the supporter 1300 to be described below. The supporter coupling groove 510 is formed along an edge of an outer circumferential surface of the coupler 500 from a center of the outer circumferential surface of the coupler 500.

The coupler 500 may have a step embossed or engraved on the outer circumferential surface to be rotatably coupled to the outside. The coupler 500 may be rotatably coupled to the upper body 1200 or the lower body 1400. In addition, the upper body 1200 or the lower body 1400 may also form a floating body coupling groove (not illustrated) on the surface on which the coupler 500 is disposed. In an exemplary embodiment of the present invention, the method of rotatably coupling the coupler 500 with the upper body 1200 or the lower body 1400 has been described, but the present invention is not limited thereto, and the coupler 500 may be detachably coupled or bonded by various coupling methods known in the prior art.

The supporter 1300 has an elastically deformable closed curve, such as a ring shape. At least a part of the supporter 1300 may be in close contact with the upper end of the lower body 1400 and the lower end of the upper body 1200. That is, the elastic supporter 1300 supports the coupling of the lower body 1400 and the upper body 1200.

The supporter 1300 may be coupled to the coupler 500. At this time, the supporter 1300 may be coupled to the coupler 500 by using any one of an adhesive, a fixing pin, a fixing plate, and a coupling unevenness.

The supporter 1300 may include a body part 1301, an upper support part 1302, and a lower support part 1303. The body part 1301 may be formed thicker than the upper support part 1302 and the lower support part 1303. Since the supporter 1300 may be formed in the same manner as the supporter 300 of FIG. 3, the detailed description thereof will be omitted. Even when the air provided in the buoyancy space of the lower body 1400 expands by heat or the like to increase the internal pressure, the supporter 1300 is formed to be elastically deformable, thereby maintaining a stable coupling force.

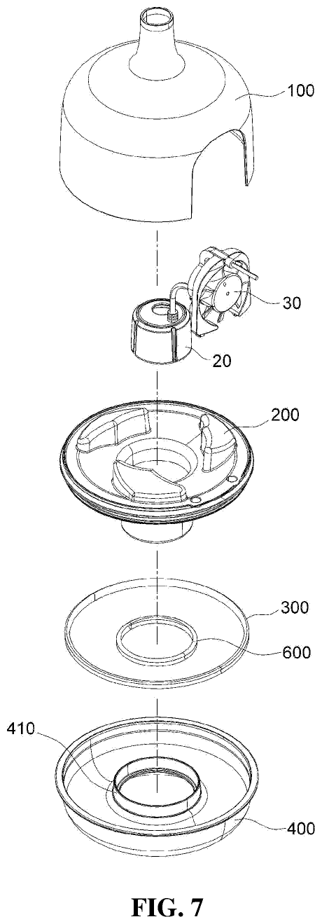

FIG. 7 is an exploded perspective view illustrating a floating-type humidifier according to yet another exemplary embodiment of the present invention.

Referring to FIG. 7, a floating-type humidifier according to yet another exemplary embodiment of the present invention, a floating-type humidifier 10 according to an exemplary embodiment of the present invention includes a cap 100, an upper body 200, a supporter 300, a lower body 400, an auxiliary supporter 600, and the like. In the specification of the present invention, since like reference numerals refer to like components, the detailed description of the components described in the previous exemplary embodiment will be omitted.

The auxiliary supporter 600 has an elastically deformable closed curve, such as a ring shape. The auxiliary supporter 600 is in close contact with the upper body 200 and the lower body 400. The auxiliary supporter 600 may be made of any one of silicone, synthetic rubber, natural rubber, and soft synthetic resin.

The auxiliary supporter 600 is disposed at a contact point between a hollow tube 210 of the upper body 200 and an inlet 410 of the lower body 400. The auxiliary supporter 600 may be coupled to either the upper body 200 or the lower body 400. The appearance of the auxiliary supporter 600 may be formed to include a body part, an upper support part, and a lower support part, like the supporter 300.

According to the exemplary embodiment, even when the air provided in the buoyancy space of the lower body 400 expands by heat or the like to increase the internal pressure, the negative pressure load applied to the supporter 300 may be reduced by the elastic force of the auxiliary supporter 600.

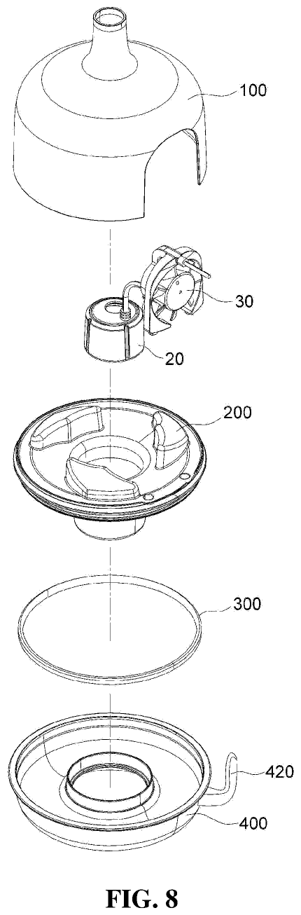

FIG. 8 is an exploded perspective view illustrating a floating-type humidifier according to another exemplary embodiment of the present invention.

Referring to FIG. 8, a floating-type humidifier according to yet another exemplary embodiment of the present invention includes a cap 100, an upper body 200, a supporter 300, a lower body 400, and the like. In the specification of the present invention, since like reference numerals refer to like components, the detailed description of the components described in the previous exemplary embodiment will be omitted.

The lower body 400 is detachably coupled to the upper body 200.

The lower body 400 further includes a detachable handle 420. The handle 420 is formed to be easily detached or attached by a user in the separation of the lower body 400 and the upper body 200.

In an exemplary embodiment of the present invention, the exemplary embodiment in which the lower body 400 includes the handle 420 has been described, but is not limited thereto, and a detachable handle may also be provided in the upper body 200. That is, a detachable handle may be provided on at least one of the lower body 400 and the upper body 200.

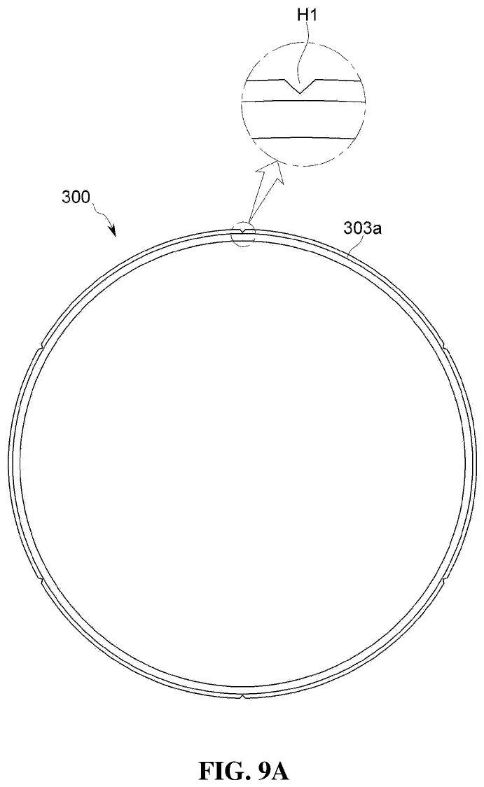

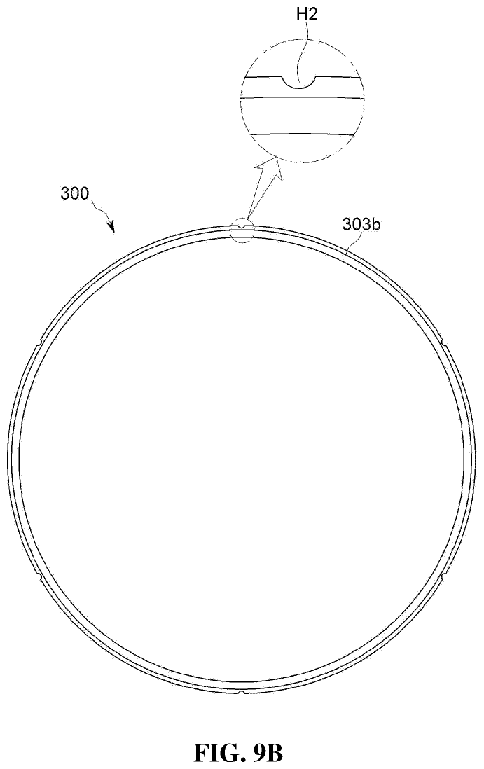

Next, FIGS. 9A and 9B illustrate modified embodiments of the supporter according to an exemplary embodiment of the present invention.

FIGS. 9A and 9B are plan views of the supporter viewed from the bottom according to an exemplary embodiment of the present invention.

FIG. 9A is a modified embodiment of the supporter illustrated in FIG. 3, and one or more grooves H1 are formed along an outer periphery of a lower support part 303a. The groove H1 may have a triangular shape of which a width decreases from the outside to the inside of the lower support part 303a. However, the present invention is not limited thereto, and as illustrated in FIG. 9B, a groove H2 may have a semicircular shape having a diameter provided on an outer periphery of a lower support part 303b, and in addition, may be variously modified in a rectangle, a polygon, and an ellipse.

In addition, in FIGS. 9A and 9B, the grooves are provided in the lower support parts 303a and 303b of the present invention, but are not limited thereto and may also be formed in the upper support part 302 (FIG. 3). That is, at least one of the upper support part 302 (FIG. 3) and the lower support parts 303a and 303b may have one or more grooves formed along the outer periphery.

When a plurality of grooves is formed, the grooves may be formed to be spaced apart from each other at regular intervals along the circumference of the supporter 300. Here, it is preferable that the spaced intervals are intervals at which the plurality of grooves is spaced apart from each other at angles of n/360 degrees with respect to the center of the supporter 300. For reference, n corresponds to the number of the plurality of grooves. For example, three grooves may be formed along the circumference of the supporter 300 and the three grooves may be spaced apart from each other at intervals of 120 degrees. As another example, four grooves may be formed along the circumference of the supporter 300 and the four grooves may be spaced apart from each other at intervals of 90 degrees. However, the grooves are not necessarily spaced apart from each other at angles of n/360 degrees with respect to the center, but may also be disposed to be freely spaced apart from each other.

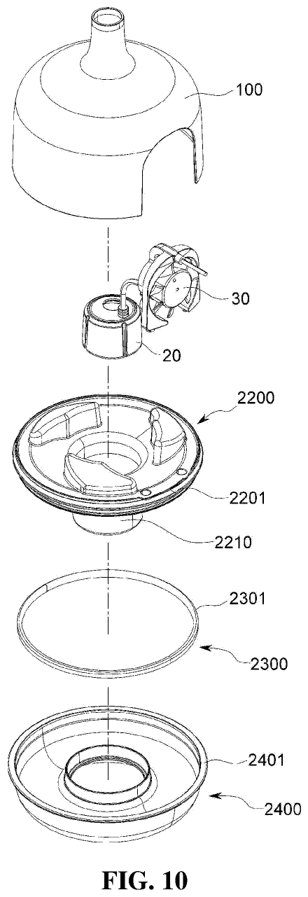

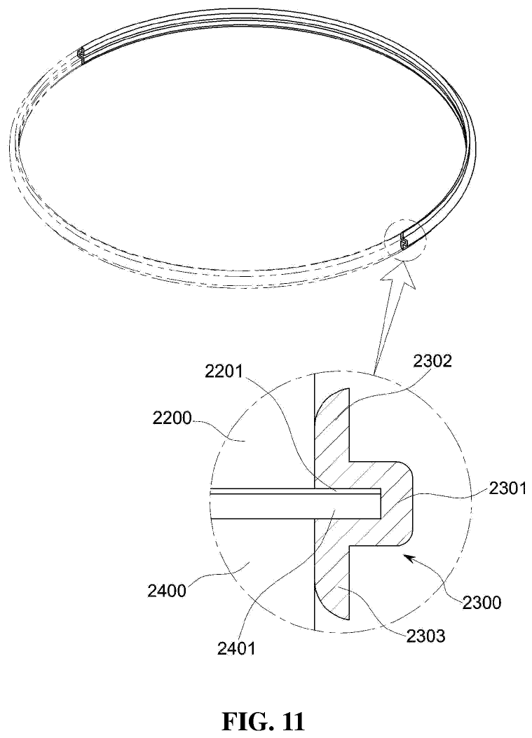

FIG. 10 is an exploded perspective view illustrating a floating-type humidifier according to another exemplary embodiment of the present invention and FIG. 11 is a perspective view illustrating a state of cross-sectionally treating a part of a supporter according to another exemplary embodiment of the present invention.

Referring to FIGS. 10 to 11, a floating-type humidifier 10 according to an exemplary embodiment of the present invention includes a cap 100, an upper body 2200, a supporter 2300, a lower body 2400, and the like. In the specification of the present invention, since like reference numerals refer to like components, the detailed description of the components described in the previous exemplary embodiment will be omitted.

The supporter 2300 has an elastically deformable closed curve, such as a ring shape. At least a part of the supporter 2300 may be in close contact with an upper end of the lower body 2400 and a lower end of the upper body 2200. That is, the elastic supporter 2300 supports the coupling of the lower body 2400 and the upper body 2200.

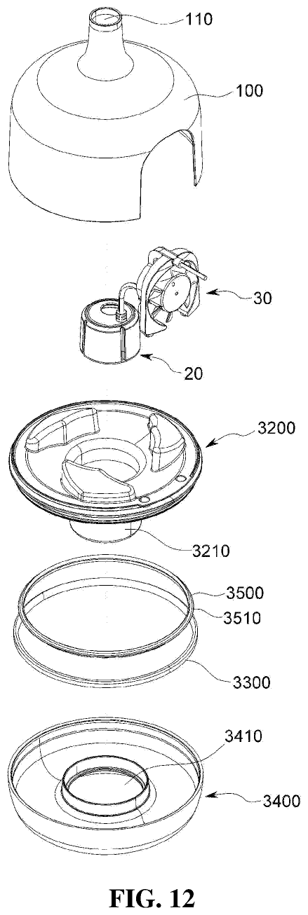

In an exemplary embodiment, as illustrated in FIG. 11, the lower body 2400 and the upper body 2200 may have coupling steps 2201 and 2401, and the coupling steps 2201 and 2401 may be fitted into the supporter 2300. This is an example for coupling between the lower body 2400, the upper body 2200 and the support body 2300, but is not limited thereto, and the lower body 2400, the upper body 2200, and the support body 2300 may be coupled by a separate coupler as described below with reference to FIG. 12.

The supporter 2300 may include a body part 2301, an upper support part 2302, and a lower support part 2303. The body part 2301 may be formed thicker than the upper support part 2302 and the lower support part 2303. Even when the air provided in the buoyancy space of the lower body 2400 expands by heat or the like to increase the internal pressure, the supporter 2300 is formed to be elastically deformable, thereby maintaining a stable coupling force.

The body part 2301 is formed in an elastically deformable ring shape. The body part 2301 may be provided with a fitting groove therein so that a coupling step 2201 of the upper body 2200 and a coupling step 2401 of the lower body 2400 may be fitted to each other, but is not limited thereto.

For example, when the upper body 2200 and the lower body 2400 do not have coupling steps 2201 and 2401, the supporter 2300 may also have no fitting groove. When the supporter 2300 has no fitting groove, the supporter 2300 may be coupled to either the upper body 2200 or the lower body 2400. At this time, for coupling, any one of an adhesive, a fixing pin, a fixing plate, and a coupling unevenness may be used.

The upper support part 2302 is formed to extend to the upper portion of the body part 2301 to be in close contact with a lower outer circumferential surface of the upper body 2200.

The lower support part 2303 is formed to extend to the lower portion of the body part 2301 to be in close contact with an upper outer circumferential surface of the lower body 2400.

At least one of the upper support part 2302 and the lower support part 2303 may be formed to be inclined outward from the body part 2301.

Accordingly, even when the air provided in the buoyancy space of the lower body 2400 expands by heat or the like to increase the internal pressure, the internal air may be easily discharged to the outside.

The supporter 2300 may be coupled to either the upper body 2200 or the lower body 2400. The supporter 2300 may be coupled to either the upper body 2200 or the lower body 2400 using any one of an adhesive, a fixing pin, a fixing plate, and a coupling unevenness.

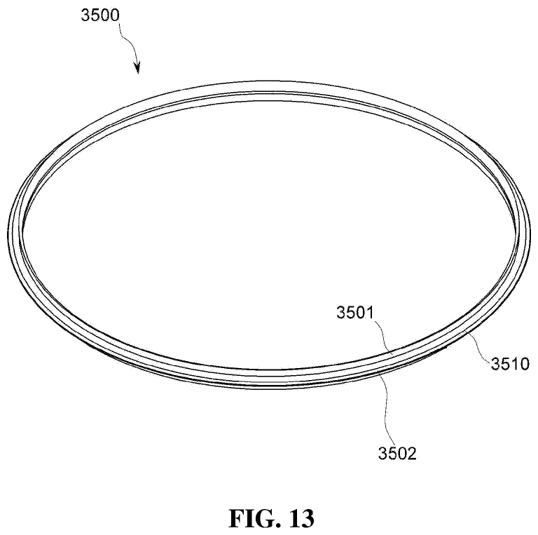

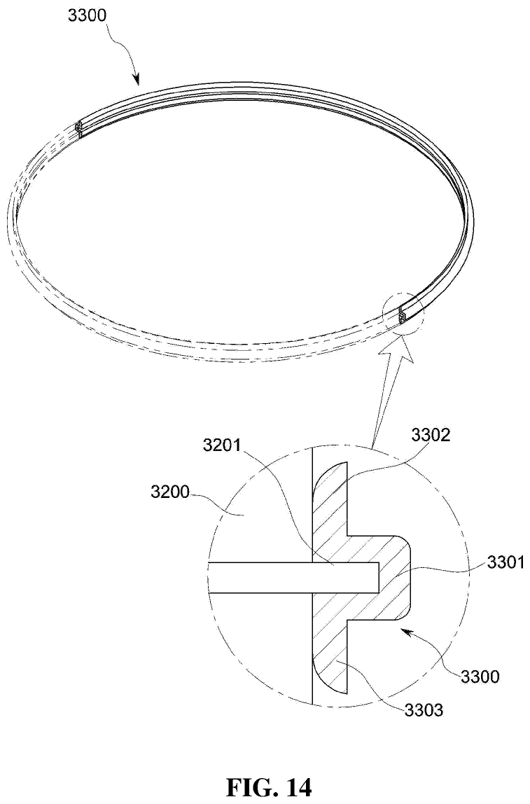

FIG. 12 is an exploded perspective view illustrating a floating-type humidifier according to another exemplary embodiment of the present invention, FIG. 13 is a perspective view illustrating a coupler according to an exemplary embodiment of the present invention, and FIG. 14 is a perspective view illustrating a state of cross-sectionally treating a part of a supporter according to another exemplary embodiment of the present invention.

Referring to FIGS. 12 to 14, a floating-type humidifier 10 according to an exemplary embodiment of the present invention includes a cap 100, an upper body 3200, a coupler 3500, a supporter 3300, a lower body 3400, and the like. In the specification of the present invention, since like reference numerals refer to like components, the detailed description of the components described in the previous exemplary embodiment will be omitted.

An upper end of the upper body 3200 may be coupled to a lower end of the cap 100, and a hollow tube 210 may be formed to vertically penetrate through the center.

The lower body 3400 is formed with a buoyancy space along an inner edge to float in water. An inlet 3410 is formed below the lower body 3400 so that water may flow in, and the inlet 3410 communicates with the hollow tube 3210 of the upper body 3200 along the upper portion.

The ultrasonic generator 20 may be provided in the hollow tube 3210 of the upper body 3200 to atomize the water flowing into the lower portion into humidified particles by ultrasonic vibration.

The coupler 3500 may be formed to have a predetermined height along the circumference of the lower end of the upper body 3200. The circumference of the lower end of the upper body 3200 and the circumference of the upper end of the lower body 3400 are almost similar to each other.

The coupler 3500 serves to couple the upper body 3200 and the lower body 3400. The coupler 3500 may further include a supporter coupling step 3510 coupled to the supporter 3300 to be described below. The supporter coupling step 3510 extends outward from a center of the outer circumferential surface of the coupler 3500 and is formed along an edge of an outer circumferential surface of the coupler 3500.

The supporter coupling step 3510 may be fitted into an inner groove of the body portion of the supporter 3300 to be coupled to the supporter 3300.

The coupler 3500 may have a step embossed or engraved on the outer circumferential surface to be rotatably coupled to the outside. Accordingly, an upper outer side 3501 of the coupler 3500 is detachably coupled to an inner side of a lower surface of the upper body 3200, and a lower outer side 3502 of the coupler 3500 may be detachably coupled to an inner side of an upper surface of the lower body 3400. In an exemplary embodiment of the present invention, the method of rotatably coupling the coupler 3500 with the upper body 3200 and the lower body 3400 has been described, but the present invention is not limited thereto, and the coupler 3500 may be detachably coupled by various coupling methods known in the prior art. However, even when the coupler 3500 is coupled to the upper body 3200 and the lower body 3400 by various coupling methods, the height of the coupler 3500 is preferably smaller than or lower than the height of the body part 3301 of the supporter 3300.

The supporter 3300 has an elastically deformable closed curve, such as a ring shape. At least a part of the supporter 3300 may be in close contact with an upper end of the lower body 3400 and a lower end of the upper body 3200. That is, the elastic supporter 3300 supports the coupling of the lower body 3400 and the upper body 3200.

The supporter 3300 may be coupled to the coupler 3500. At this time, the supporter 3300 may be coupled to the coupler 3500 by using any one of an adhesive, a fixing pin, a fixing plate, and a coupling unevenness.

The supporter 3300 may include a body part 3301, an upper support part 3302, and a lower support part 3303. The body part 3301 may be formed thicker than the upper support part 3302 and the lower support part 3303. Even when the air provided in the buoyancy space of the lower body 3400 expands by heat or the like to increase the internal pressure, the supporter 3300 is formed to be elastically deformable, thereby maintaining a stable coupling force.

The body part 3301 is formed in an elastically deformable ring shape. The body part 3301 may be provided with a fitting groove on the inner side so that the supporter coupling step 3510 may be fitted, but is not limited thereto.

For example, when the upper body 3200 and the lower body 3400 do not have coupling steps 2201 and 2401 (FIG. 11), the supporter 3300 may also have no fitting groove. When the supporter 3300 has no fitting groove, the supporter 3300 may be coupled to either the upper body 3200 or the lower body 3400. At this time, for coupling, any one of an adhesive, a fixing pin, a fixing plate, and a coupling unevenness may be used.

The upper support part 3302 is formed to extend to the upper portion of the body part 3301 to be in close contact with a lower outer circumferential surface of the upper body 3200.

The lower support part 3303 is formed to extend to the lower portion of the body part 3301 to be in close contact with an upper outer circumferential surface of the lower body 3400.

At least one of the upper support part 3302 and the lower support part 3303 may be formed to be inclined outward from the body part 3301.

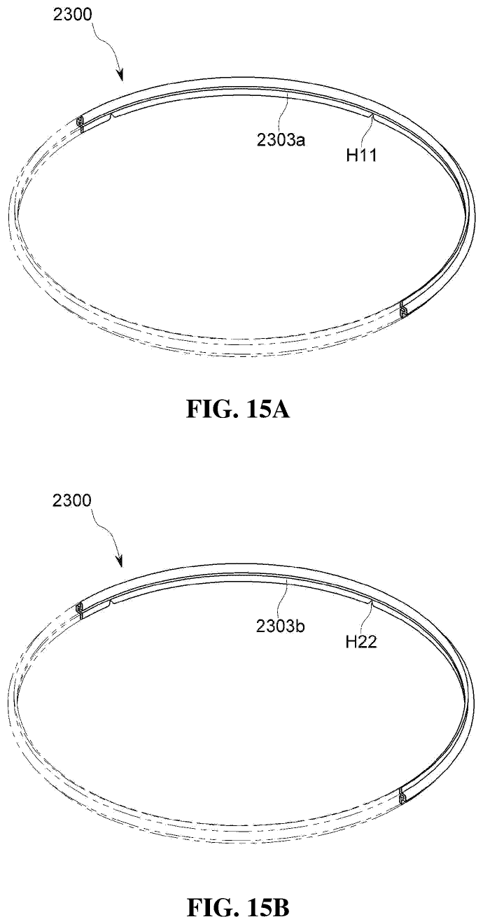

Next, FIGS. 15A and 15B illustrate modified embodiments of the supporter according to an exemplary embodiment of the present invention.

FIG. 15A is a modified embodiment of the supporter illustrated in FIG. 11, and one or more grooves H11 and H12 are formed along an outer periphery of lower support parts 2303a and 2203b. The groove H11 may have a triangular shape of which a width decreases from the lower end to the upper end of the lower support part 2303a. However, the present invention is not limited thereto, and as illustrated in FIG. 15B, the groove H12 may have a semicircular shape having a diameter provided on the lower end, and in addition, may be variously modified in a rectangle, a polygon, and an ellipse.

In addition, in FIGS. 15A and 15B, the grooves H11 and H12 are provided in the lower support parts 2303a and 2203b of the present invention, but are not limited thereto and may also be formed in the upper support part 2302 (FIG. 11). That is, at least one of the upper support part 2302 and the lower support part 2303 may have one or more grooves formed along the outer periphery.

When a plurality of grooves is formed, the grooves may be formed to be spaced apart from each other at regular intervals along the circumference of the supporter 2300. Here, it is preferable that the spaced intervals are intervals at which the plurality of grooves is spaced apart from each other at angles of n/360 degrees with respect to the center of the supporter 2300. For reference, n corresponds to the number of the plurality of grooves. For example, three grooves may be formed along the circumference of the supporter 2300 and the three grooves may be spaced apart from each other at intervals of 120 degrees. As another example, four grooves may be formed along the circumference of the supporter 2300 and the four grooves may be spaced apart from each other at intervals of 90 degrees. However, the grooves are not necessarily spaced apart from each other at angles of n/360 degrees with respect to the center, but may also be disposed to be freely spaced apart from each other.

Although the detailed exemplary embodiments of the present invention have been described up to now, various modifications of the present invention can be made without departing from the scope of the present invention. Therefore, the scope of the present invention should not be limited to the exemplary embodiments and should be defined by the appended claims and equivalents to the appended claims.

Although the present invention has been described by the limited exemplary embodiments and drawings, the present invention is not limited to the exemplary embodiments and various modifications and transformations can be made by those skilled in the art from the disclosure. Therefore, the spirit of the present invention should be construed based on the following claims and all equivalents or equivalent modifications thereto should be construed as falling within the scope of the spirit of the present invention.

### EXPLANATION OF REFERENCE NUMERALS AND SYMBOLS

10: Floating-type humidifier
100: Cap
200: Upper body
210: Hollow tube
300: Supporter
400: Lower body
410: Inlet
500: Coupler
600: Auxiliary supporter

1. A floating-type humidifier comprising:
a lower body which has a buoyancy space formed along an inner edge to float in water and has a water inlet formed so that water flows into a lower center;
an upper body formed with a hollow tube communicable with the water inlet; and
a supporter formed in an elastically deformable closed curve,
wherein the supporter is in contact with an upper end of the lower body and a lower end of the upper body to couple the lower body and the upper body to each other.

2. The floating-type humidifier of claim 1, further comprising:
a coupler which is detachably coupled to the upper end of the lower body and the lower end of the upper body,
wherein the supporter is coupled to the coupler.

3. The floating-type humidifier of claim 1, wherein the supporter is coupled to either the upper end of the lower body or the lower end of the upper body.

4. The floating-type humidifier of claim 2, wherein the supporter is coupled using any one of an adhesive, a fixed pin, a fixed plate, and a coupling unevenness.

5. The floating-type humidifier of claim 1, wherein the supporter includes
a body part formed in an elastically deformable ring shape;
an upper support part which extends to an upper portion of the body part to be in close contact with a lower outer circumferential surface of the upper body; and
a lower support part which extends to a lower portion of the body part to be in close contact with an upper outer circumferential surface of the lower body.

6. The floating-type humidifier of claim 5, wherein at least one of the upper support part and the lower support part has one or more grooves formed along an outer periphery thereof.

7. The floating-type humidifier of claim 6, wherein the grooves are formed in any one shape of a triangle, a rectangle, a polygon, a semicircle, and an ellipse.

8. The floating-type humidifier of claim 5, wherein at least one of the upper support part and the lower support part is formed to be inclined outward from the body part.

9. The floating-type humidifier of claim 1, wherein the supporter is made of any of silicone, synthetic rubber, natural rubber, and soft synthetic resin.

10. The floating-type humidifier of claim 1, wherein at least one of the upper body and the lower body has a detachable handle.

11. The floating-type humidifier of claim 1, further comprising:
an auxiliary supporter which is formed in an elastically deformable ring shape and disposed to be in contact with the water inlet of the lower body and a communication part of the hollow tube.

12. The floating-type humidifier of claim 3, wherein the supporter is coupled using any one of an adhesive, a fixed pin, a fixed plate, and a coupling unevenness.
